(19) United States
(12) Patent Application Publication
(10) Pub. No.: US 2022/0042660 A1
(43) Pub. Date: Feb. 10, 2022

(54) Christmas Light Shells

(71) Applicant: Stevie Alexander, Kodak, TN (US)

(72) Inventor: Stevie Alexander, Kodak, TN (US)

(21) Appl. No.: 17/300,407

(22) Filed: Jun. 16, 2021

Related U.S. Application Data
(63) Continuation-in-part of application No. 16/873,824, filed on Jul. 17, 2020, now abandoned.

(51) Int. Cl. F21S 4/10; F21V 3/02; F21V 7/04

(52) U.S. Cl. CPC F21S 4/10; F21V 7/04; F21V 3/02

(57) ABSTRACT

The reflector shell comes in three sizes of twelve, eight and four inches in diameter across. They are constructed from lightweight aluminum or hard weather resistant plastic. A faceted strawberry shaped LED indoor/outdoor lamp/light bulb from a strand of Christmas lights is used to attach the shell by removing one bulb and aligning the porta/hole from the shell with the hole to the bulb socket and replacing the bulb back into the socket and screwing it until it is tight/snug securing the shell in place. The reflector shell reflects the color of the lamp/bulb or the shell can be made into a variety of colors or with a glitter surface for different holiday or special events.

### CROSS-REFERENCE TO RELATED APPLICATIONS

yes

### STATEMENT REGARDING FEDERALLY SPONSORED RESEARCH OR DEVELOPMENT

none

### THE NAMES OF THE PARTIES TO A JOINT RESEARCH AGREEMENT

none

### INCORPORATION-BY-REFERENCE OF MATERIALMSUBMITTED ON A COMPACT DISC OR AS A TEXT FILE VIA THE OFFICE ELECTRONIC FILING SYSTEM (EFS-WEB)

none

### STATEMENT REGARDING PRIOR DISCLOSURES BY THE INVENTOR OR A JOINT INVENTOR

none

### BACKGROUND OF THE INVENTION

### (1) Field of the Invention

Holiday Decorations

### (2) Description of Related Art Including Information Disclosed Under 37 CFR 1.97 and 1.98

none

### BRIEF SUMMARY OF THE INVENTION

This unique design can be easily attached to a strand of indoor/outdoor holiday LED lights with a strawberry shaped bulb. This product will enhance the illumination of the bulb color and give off a brighter reflection.

### BRIEF DESCRIPTION OF THE SEVERAL VIEWS OF THE DRAWING(S)

FIG. 1

1. Top view of reflector shell in circular form with scalloped/semicircle edges

2. Twelve-millimeter center hole/porta for attaching shell(s) to strand of holiday lights

FIG. 2

1. Side view of reflector shell

2. Faceted strawberry shaped LED indoor/outdoor lamp/light bulb

3. Flat portion of lamp/bulb electrical component or socket

4. Electrical component or socket

5. Wiring connecting each individual electrical component or socket to entire strand of lights

### DETAILED DESCRIPTION OF THE INVENTION

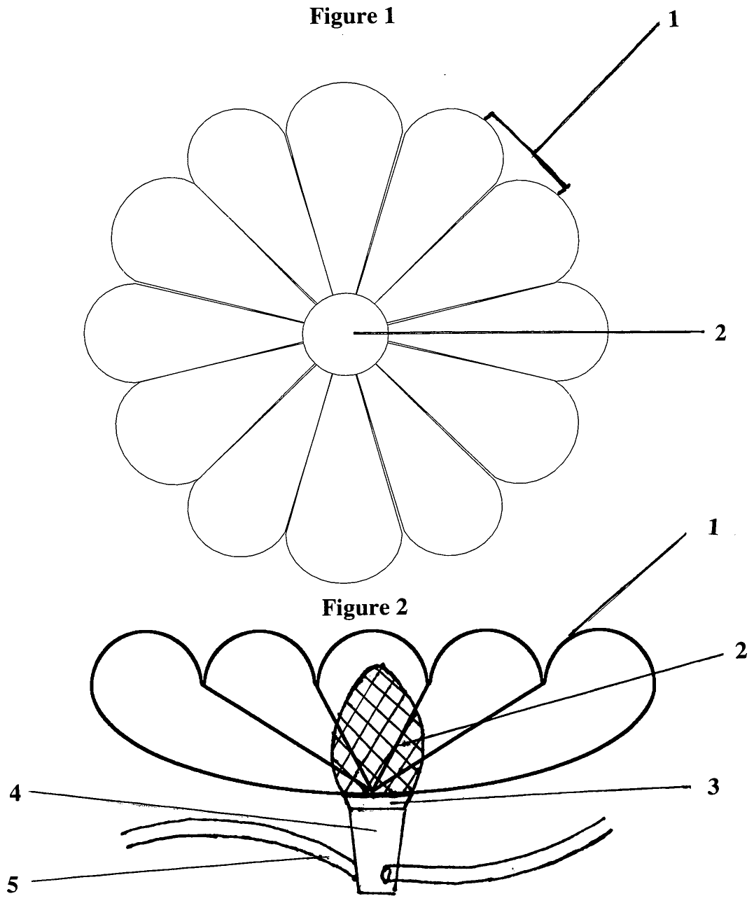

This design is a unique and new way to enhance and illuminate the glowing color from a strand of faceted strawberry shaped LED indoor/outdoor lamp/bulb shown in (FIG. 2-2). The shell is made from lightweight aluminum or a hard weather resistant plastic. The scalloped/semicircle edges shown in (FIG. 1-1) gives the shell a more ornamental look when decorating for holidays or special events such as weddings, anniversaries or advertising a specific happening. The artwork also shows that the shell is a solid piece so that the entire surface catches all the light from the lamp/bulb. The shallow bowl or concave shape shown in (FIG. 2-1) along with a smooth reflective or glitter surface for an additional sparkle effect helps to enhance and concentrate the light from the lamp/bulb enabling the shell to project the light from the lamp/bulb forward causing it to be more visible in the night or from a farther distance. The shell comes in sizes twelve, eight or four inches in diameter across from side to side shown in (FIG. 1-1), which can be used all at once or in various patterns for the event being decorated with the reflector shell(s). The twelve-millimeter center hole or porta in the shell shown in (FIG. 1-2) is used to attach the shell to the strand of lights. A single lamp/bulb is removed from a single electrical component or socket shown in (FIG. 2-3,4) of the entire strand of lights by unscrewing the bulb/lamp from its electrical component or socket and placing or resting a single shell on the flat portion of the electrical component or socket shown in (FIG. 2-3) and lining up the center hole/porta of the shell shown in (FIG. 1-2) with the opening of the electrical component or socket and screwing the lamp/bulb back into its connection until it is tight and secures the shell into place. Each electrical component or socket is connected by wiring shown in (FIG. 2-5) creating a length or complete strand of lights. The strand of lights can be secured into position for decorating prior to attaching the shell(s) to each of the lamp/bulbs. The shell(s) can be made into a variety of colors to represent different holidays or events. The same size shell(s) or a pattern of the shell(s) sizes can be used in addition to a color or colors of shell(s) to enhance the desired look for any occasion.

1. Christmas Light Shell with related objects in view, consists in the construction, combination and arrangements of parts hereinafter described and claimed.
In the accompanying drawings illustrating the invention;
FIG. 1 is top view of improved reflector shell;
FIG. 2 is side/sectional view of reflector shell applied to a lamp/bulb;
referring to drawings 1-1 designates the reflector shell with scalloped or semicircle edges with a diameter of twelve, eight or four inches across;
wherein referring to prior art, the reflector shell is solid without any cutouts other than the Center porta or opening allowing the light from a single lamp/bulb to be reflected without loss of the lamp/bulb illumination and enabling the illumination from the lamp/bulb color to be viewed at night and from a distance;
wherein referring to prior art, the reflector shell is constructed of lightweight aluminum or a hard plastic making it weather resistant, it is therefore conducive and very favorable for use in indoor and outdoor decorating during all seasons and weather conditions;
the surface of the entire reflector shell is smooth or with a glitter surface, which is constructed in a variety of colors to be used for a variety of holiday, seasonal or promotional events;
referring to drawings 1-2 designates to the reflector shell twelve-millimeter porta/center hole used to attach the reflector shell to a single lamp/bulb fixture as part of a strand of lights, referring to drawings 2-1 designates the side or sectional view of the reflector shell;
the art shows the reflector shell to have a concave or shallow bowl like construction, which forces the light from a lamp/bulb to be concentrated into the entire reflector and cause it to radiate forward and more brightly;
wherein referring to prior art, it is claimed (1) referring to drawings 2-2 designates a faceted strawberry shaped LED indoor/outdoor lamp/bulb, which is a larger body than traditional smaller round or rice like shaped lamps/bulbs that aids in securing the reflector shell to a single lamp/bulb and to the entire strand of lights;
it is claimed (2) referring to drawings 2-3 designates the flat portion of the lamp/bulb socket, which serves as the platform that the reflector shell rests on;
it is claimed (3) referring to drawings 2-4 designates the electrical component or socket, which the lamp/bulb is connected to and gives power to light up in its color when the lamp/bulb is unscrewed or detached from the socket and the reflector shell of choice is made, lining up the porta/center hole of the reflector shell with the electrical component or socket opening and the lamp/bulb is replaced again screwing in tightly until snug making the reflector shell secure to the individual lamp/bulb and the entire strand of lights;
it is claimed (4) referring to drawings 2-5 designates to the wires connecting each of the individual electrical components or sockets on the entire strand of lights and providing the necessary electrical current needed to cause the individual lamps/bulbs to glow their color(s) and provide the necessary light needed to reciprocate onto the reflector shell for the full effect of the colored lamp/bulb or the color of the reflector shell.
